(19) United States
(12) Patent Application Publication
(10) Pub. No.: US 2009/0111084 A1
(43) Pub. Date: Apr. 30, 2009

(54) Method of sequencing multiple simulated flashcards for effective learning

(76) Inventor: Darren Patrick Mccarty, Rochester, NY (US)

Correspondence Address: Gilford F. Martino, 462 Country Knoll Drive, Endwell, NY, 13760, US

(21) Appl. No.: 11/857,494

(22) Filed: Sep. 19, 2007

(51) Int. Cl. G09B 7/00

(52) U.S. Cl. 434/323; 434/327; 434/362

(57) ABSTRACT

A method of displaying information for learning purposes comprises the steps of providing within a computer an information set. The information set includes a plurality of discrete information element pairs. Each discrete information element pair has a cue element and a response element. Each cue and response element pair is sequenced over a plurality of simulated flashcards. The information set is caused to be arranged for display within the computer in a deliberate sequence.

### REFERENCES CITED [REFERENCED BY]

U.S. Patn. Documents

| | | |
|---|---|---|
| 3638196 | January 1972 | Nishiyama et al. |
| 4194301 | March 1980 | Caldwell |
| 4439161 | March 1984 | Wiggins et al. |
| 4447213 | May 1984 | Culley |
| 4509137 | April 1985 | Yoshida |
| 4637797 | January 1987 | Whitney et al. |
| 4802103 | January 1989 | Faggin et al. |
| 4921427 | May 1990 | Dunn |
| 4946391 | August 1990 | Hawkins et al. |
| 5010495 | April 1991 | Willets |
| 5161977 | November 1992 | Thomas, Jr. |
| 5261823 | November 1993 | Kurokawa |
| 5267865 | December 1993 | Lee et al. |
| 5295228 | March 1994 | Koda et al. |
| 5316485 | May 1994 | Hirose |
| 5437553 | August 1995 | Collins et al. |
| 5442782 | August 1995 | Malatesta et al. |
| 5486111 | January 1996 | Watckins |
| 5494444 | February 1996 | Thayer et al. |
| 5503560 | April 1996 | Stentiford |
| 5545044 | August 1996 | Collins et al. |
| 5555439 | September 1996 | Higashino et al. |
| 5577919 | November 1996 | Collins et al. |
| 5597312 | January 1997 | Bloom et al. |
| 5627945 | May 1997 | Cohen |
| 5675710 | October 1997 | Lewis |
| 5727951 | March 1998 | Ho et al. |
| 5779486 | July 1998 | Ho et al. |
| 5797753 | August 1998 | Griswold et al. |
| 5797754 | August 1998 | Griswold et al. |
| 5836771 | November 1998 | Ho et al. |
| 5863208 | January 1999 | Ho et al. |
| 5870731 | February 1999 | Trif et al. |
| 5885087 | March 1999 | Thomas |
| 5890911 | April 1999 | Griswold et al. |
| 5934910 | August 1999 | Ho et al. |
| 5957699 | September 1999 | Peterson et al. |
| 5967793 | October 1999 | Ho et al. |
| 5987443 | November 1999 | Nichols et al. |
| 6003021 | December 1999 | Zadik et al. |
| 6022221 | February 2000 | Boon |
| 6039575 | March 2000 | L'Allier et al. |
| 6077085 | June 2000 | Parry et al. |
| 6086382 | July 2000 | Thomas |
| 6120300 | September 2000 | Ho et al. |
| 6206700 | March 2001 | Brown et al. |
| 6216869 | April 2001 | Zhang |
| 6306086 | October 2001 | Buscke |
| 6588756 | July 2003 | Hughes |
| 6606479 | August 2003 | Cook et al. |
| 6652283 | November 2003 | Van Schaack |
| 6685482 | February 2004 | Hopp et al. |
| 6884076 | April 2005 | Clark et al. |
| 6964608 | November 2005 | Koza |
| 7013242 | March 2006 | Gilmartin et al. |
| 7011525 | March 2006 | Mejia |

### FIELD OF THE INVENTION

The disclosed invention is to a method of simulating a plurality of flashcards in order to enhance learning. More particularly, the disclosed invention is directed to a computer system which displays flashcards in a sequence to encourage learning, where each flashcard has a cue element and an unrelated response element. With a plurality of flashcards the standard cues and responses are distributed over more than one flashcard.

### BACKGROUND OF THE INVENTION

Most educational institutions require that the student demonstrate recollection of specific items of information or categories of information. A test or examination is one well-known means by which a teacher establishes whether a student has grasped the information which was communicated during a particular course, seminar, workshop, or the like. Not only must the student establish that categories of information have been learned, but it is also frequently necessary for the student to establish that particular items of information within that category have been learned or memorized. A student may be called upon to demonstrate this recollection on more than one occasion, so there is frequently a need for the student to be able to demonstrate recollection of items of information which were “learned” at some point in the past.

Mnemonics is the art of improving or developing the memory, and incorporates a number of tools utilized by students for assuring that information not only is learned but remains learned. One tool of mnemonics is the use of flashcards, either prepared by the student or otherwise produced. A flashcard may have any shape, size, or material of construction, but generally is a relatively small, flat, two-sided piece of stiff paper. A 3.times.5 index card is one well-known format for a flashcard, and because it is blank it permits the student to select the information which is to be learned. The flashcard typically has a first or “cue” side on which a question or item of interest is written, printed, or the like, and a second or “response” side on which the answer is placed.

In a well known prior art method, a paired-associate learning method is embodied in a group of flashcards which may be presented manually or electronically via a computer, for example. In a typical example of such a method, a student starts by separating flashcards into two groups: known and unknown. The student studies each unknown flashcard by first viewing the question on one side of the flashcard and then formulating a response to the question. The student then turns the card over and views the answer provided. The student judges the adequacy of his response by comparing his answer to the correct answer. If the student believes he has learned or “knows” the paired-associate, that flashcard is placed in the group of known items. When the student has studied all of the flashcards in the first unknown group, and all of the flashcards have been transferred to the group of known flashcards, the student may review the group of known items in the same manner as described above. In an alternative method, the cards can be shuffled for learning. Thus, in this method, the learning and review is performed by a student simply looking at flashcards to determine correct responses and reviewing the flashcards as desired, with no fixed schedule or sequence.

In another method invented by B. F. Skinner, a method of learning and reviewing is provided. More specifically, Skinner discloses a machine which presents a number of paired-associate questions and answers. The learning machine has an area for providing questions, and an area where the user writes in an answer to these questions. At the time the question is presented, the correct answer is not visible. A student reads a question and then writes in an answer in the area provided. The user turns a handle which causes a clear plastic shield to cover his answer while revealing the correct answer. The user judges the adequacy of his response. If the user judges that his answer is adequate, he slides a lever which punches a hole in the question and answer sheet and turns a handle revealing the next question. If the answer is judged to be inadequate, the user simply turns a handle revealing the next question. After all of the questions have been answered a first time, the user can make a second pass through the questions and answers. The machine operates such that only the questions which were answered incorrectly in the first pass are viewable during the second pass so as to provide a review of questions which were answered incorrectly. Thus, this conventional method provides a crude method of enabling review of missed questions.

A slightly more advanced method was invented by Sebastian Leitner and described in “So Lernt Man Lernen.” The method involves studying flashcards as in the method described above, but in addition, involves using a specially constructed box to calculate review schedules. More specifically, the box has five compartments increasing in depth from the first compartment to the fifth compartment. According to Leitner's method, a student takes enough “unknown” flashcards to fill the first compartment and places them in the first compartment. The student begins by taking the first card out of the box and reading the question. The student then constructs an answer and compares it to the correct answer on the back of the card. If the student is connect, the student places the flashcard in the second compartment. If the student cannot construct an answer, or if the student's answer is incorrect, the student places the flashcard at the back of the group of cards in the first compartment. This process continues until all of the cards have been moved to the second compartment and the student stops the learning session. The next learning session begins by placing new “unknown” cards into the first compartment. The process of studying and sorting is performed as described above until once again, no cards remain in the first compartment. At some future date, the second compartment will be full of cards placed there during previous learning sessions. At that time, the student begins to study the cards in the second compartment, except this time, known cards are placed into the third compartment and unknown cards are placed backed into the first compartment. New cards are continually introduced into the first compartment and are moved through the compartments as they are learned and reviewed Cards that are easily remembered or known are moved from the more shallow compartments to the deeper compartments and therefore are reviewed less and less frequently. Cards that are more difficult to learn are put back into the more shallow compartments for more frequent review. This method provides a crude form of scheduled review of learned items based on item difficulty.

A computer-based version of Leitner's method is provided in the German language computer software program entitled Lernkartei PC 7.0 and in the Spanish language computer software entitled ALICE (Automatic Learning In a Computerized Environment) 1.0. With ALICE 1.0, question and answer units are presented to a user and the number of cards and interval of time between study sessions are distributed to adapt to a user's work habits.

Other conventional methods have recognized the importance of developing a system to present items for review. For example, a computer program developed by Piotr Wozniak in Poland and referred to as “SuperMemo” uses a mathematical model of the decline of memory traces to determine spacing of repetitions to maintain long term retention of paired-associates.

In another prior art method described in U.S. Pat. Nos. 5,545,044, 5,437,553 and 5,577,919 issued to Collins et al., paired-associates are presented to a user for learning. However, unlike the conventional methods described above, in this invention, the user is first queried as to whether a particular item is perceived to be known or unknown, not whether the user actually knows the item, or knows the correct answer to a question. That is, a user is asked to determine whether they think they know the correct response to the cue, not what the correct response actually is. Then, a sequence of perceived known items and perceived unknown items is generated and presented to the user in the form of cue and response for learning. Similar to the first conventional method described above, the question of the perceived known or unknown items is presented to a user, the user constructs a response to the presented cue and then compares the constructed response to the correct response.

In another prior art method described in U.S. Pat. Nos. 6,652,283 issued to Van Schaak et al., an entire learning, retaining and retrieving knowledge is presented to enhance learning. However, like the conventional methods, this method provides typical simulated flashcards with a cue element and a related response element. This patent does discuss sequences of typical cue/response flashcards to enhance learning, by removing those flashcards that are learned and adapting the sequence while using the Learn and Review Modules. The Modules are changed based on a user's past performance within one or more of the three modules. This method intentionally changes the sequence during learning.

Current flashcard applications provide the user with the means to enter data in a table with two or more columns, where each table row represents various pieces of information related to a single item. For example, a row might contain a word, its translation into French, and the definition of the word in French. These applications generate one or more types of quizzes based on two of the columns in the table. Correct answers are determined from the table. One such system is described in U.S. Pat. No. 5,494,444. The ability to generate quizzes from data represented in a table is very useful, but does not address the need to generate quizzes for learning materials represented in a sequence.

The prior art methods described above have generally proven to be only marginally effective for learning, retaining and retrieving knowledge. It can be seen from the above that there is a need for entertaining computer software which encourages learning. That by permitting an instructor or teacher to enter flashcard paired associate items in a particular sequence; can enhance learning. The disclosed invention meets these needs and overcomes the noted disadvantages through use of computer software.

### SUMMARY OF THE INVENTION

The principal object of the disclosed invention is a method of displaying information in the form of multiple simulated flashcards where the flashcards are in a sequence, with a cue element of the discrete information element pair on one flashcard and the related response element of the discrete information element pair on a second flashcard, for learning purposes or for entertainment for example by way of trivia.

A method of displaying information for learning purposes according to the invention comprises the steps of providing within a computer an information set. The first information set includes a plurality of discrete information element pairs. Each discrete information element pair is defined as a ‘cue’ element and an associated ‘response’ element. All of the discrete information element pairs in the information set are caused to be arranged for display within the computer in a pre-determined sequence. The predetermined sequence may be random where the order is not important as in multiplication tables; or the predetermined sequence may be organized in an order that follows a beginning, middle and end, such as a book, or a video. The discrete information element pairs are then displayed with a display operably associated with the computer in the specified sequence.

A method of using simulated flashcards, according to the invention, comprises the steps of inputting into a computer a plurality of information element pairs simulating a set of flashcards. Each simulated flashcard has a cue element and a response element, however in this method of learning the discrete information element pairs are not on the same flashcard. The simulated flashcards are arranged within the computer based upon a predetermined sequence. All information element pairs in a set or a pre-selected portion of the information element pairs of the simulated flashcards are then displayed with a display operably associated with the computer in the sequence.

Unlike other simulated flashcard systems, this method of learning displays the cue element to the user on one flashcard and requires the user to select the appropriate response element from another flashcard. This then employs all flashcards in the information set in a sequence in order to complete the set. Upon selecting the correct response to the associated cue, the response element of the selected flashcard reveals a new cue element and the former response element is hidden. In kind the first cue element is hidden and reveals what will be the final response element of the sequence.

These and other objects and advantages of the invention will be readily apparent in view of the following description and drawings of the above-described invention.

### DESCRIPTION OF THE DRAWINGS

The above and other objects and advantages and novel features of the present invention will become apparent from the following detailed description of the preferred embodiment of the invention illustrated in the accompanying drawings, wherein:

FIG. 1 is a schematic view of a computer system according to the invention;

FIG. 2 is an elevational view of another computer screen when the simulated flashcards of the invention are being reviewed;

FIG. 3 is an elevational view of another computer screen when the simulated flashcards of the invention are being executed after FIG. 2;

FIG. 4 is an elevational view of another computer screen when the simulated flashcards of the invention are being executed after FIG. 3;

FIG. 5 is an elevational view of another computer screen when the simulated flashcards of the invention are being executed after FIG. 4;

FIG. 6 is a flow chart of the high level commands of the invention;

FIG. 7 is a flow chart expanding upon a portion of the flow chart of FIG. 6;

FIG. BubbaBrainWorkingModel1 is a snapshot on the world wide web, of the current functioning software and its home page.

FIG. BubbaBrainWorkingModel2TimesTbl is a snapshot on the world wide web, of the current functioning software and its example of a Math two times tables.

### DETAILED DESCRIPTION OF THE INVENTION

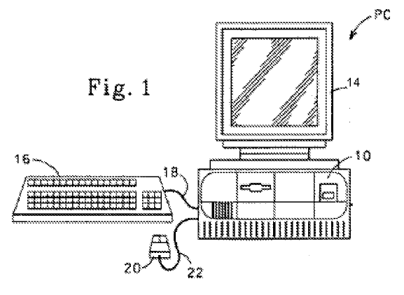

Personal computer system PC, as best shown in FIG. 1, includes a personal computer 10, an operably associated CRT display or monitor 14, and an operably associated keyboard 16. Keyboard 16 may be integral with computer 10, or may be connected thereto through cord 18. Keyboard 16 preferably has a “mouse” integral therewith for use in implementing the invention. Alternatively, a mouse 20 may be provided, and which is connected to computer 10 by cord 22. Personal computer 10 preferably has an enhanced graphics interface, such as through use of the Windows system.

Flashcards are usually created in information “sets”, with each set containing no particular number of flashcards. Thus, a set of flashcards on the general topic “multiplication” would have a number of topics within that set or category. One topic, for example, could be “the two times tables”, with other topics being “the three times tables”, “the four times tables”, or any other subcategory of information which are desired.

Each set of flashcards has a minimum of 2 cards with no maximum number of cards in the set. There is no maximum number of information topics or sets. In addition, any number of sets may be open at the same time. Any number of users can be logged into the web site or program at any one time.

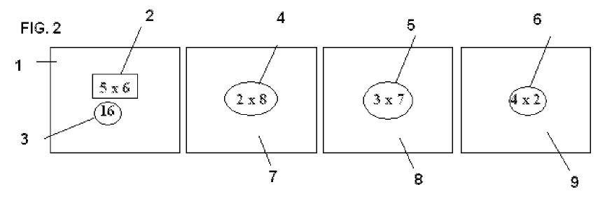

FIG. 2 discloses a computer screen displayed on monitor 14 when the invention is in the execution mode. Cue element 3 represents one “side” of a flashcard with response elements 2, 4, 5, and 6 representing the opposite “side” of each of the four flashcards. All response elements are displayed. The user needs to find the response which solves or best solves the displayed cue element 3, and the user will need to follow the sequence that the flashcards have been initialized too. In this case the flashcard 7 is the correct choice for the user to select. When the user uses mouse 20 to select response element 4 because 2×8 =16, cue element 3 will disappear and a new cue element will replace response element 4. Upon making the first selection the timer will begin to record the amount of time it takes the user to complete the entire sequence of cues and responses. When the user uses mouse 20 to select each response these selections will be counted and called “clicks”, correct clicks and incorrect clicks will be counted until the entire sequence is complete. Other statistical data will be kept as well, like the hardest cue and response element pair based on all sequences engaged. If the user selected either of the other response cues, an error would be prompted to the user to notify the user that an incorrect selection had been chosen.

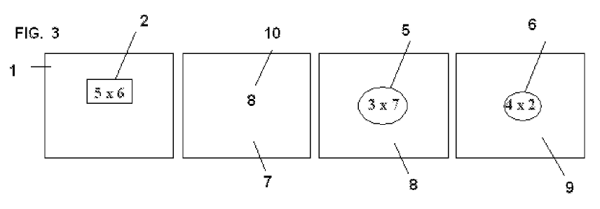

FIG. 3 discloses a computer screen displayed on monitor 14 when the invention is in the execution mode, this is a continuation of FIG. 2. Cue element 10 represents the back of the flashcard and is the cue to be solved; the user needs to find the response cue that best solves cue element 10. When the user uses mouse 20 to select response element 6 because 4×2 =8, cue element 10 will disappear and a new cue element will replace response element 6.

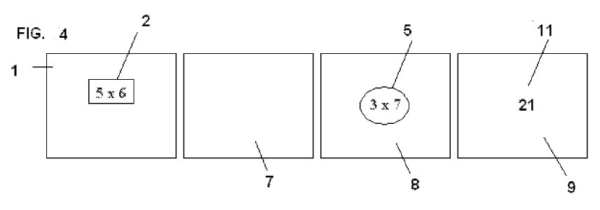

FIG. 4 discloses a computer screen displayed on monitor 14 when the invention is in the execution mode, this is a continuation of FIG. 3. Cue element 11 represents the back of the flashcard and is the cue to be solved; the user needs to find the response cue that best solves cue element 11. When the user uses mouse 20 to select response element 5 because 3×7 =21, cue element 11 will disappear and a new cue element will replace response element 5.

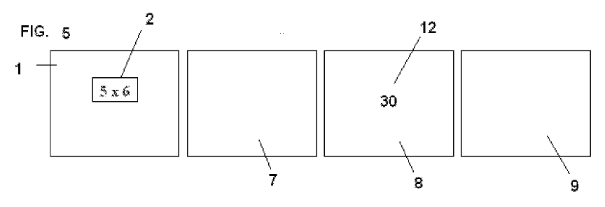

FIG. 5 discloses a computer screen displayed on monitor 14 when the invention is in the execution mode, this is a continuation of FIG. 4. Cue element 12 represents the back of the flashcard and is the cue to be solved; the user needs to find the response cue that best solves cue element 12. When the user uses mouse 20 to select response element 2 because 5×6 =30, cue element 12 will disappear, the clock will stop because the user completed the entire sequence. The click counter will have increased one more time and the results of the amount of time to complete the sequence, the number of correct and incorrect clicks will all be displayed to the user in some way.

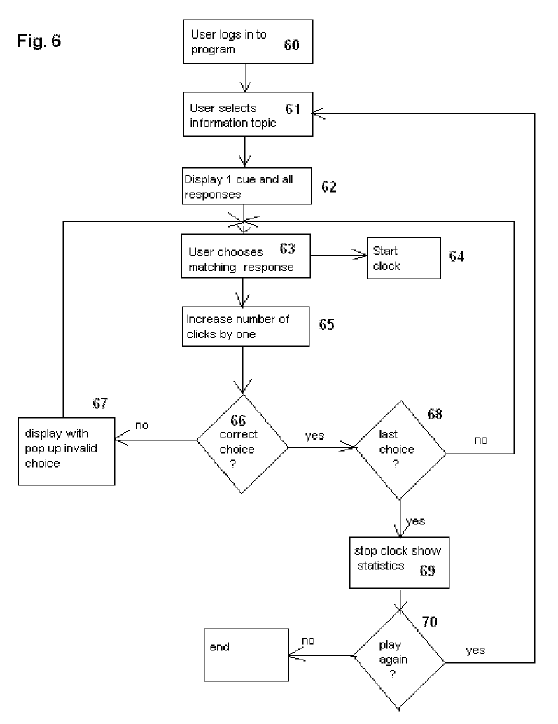

Upon the program being launched at 61 as best shown in FIG. 6, the user selects the information topic to be learned. Then at 62 the computer display 14 shows one cue and all the responses. The user chooses the matching response to the cue from 62, in 63. The clock starts in 64 and the number of clicks is incremented by one in 65. If the user selected with mouse 20 the correct response to the cue in 62, the correct answer from 66 will then determine if the correct response is the last response in the sequence in 68. If the response is not the last response then the program returns to 63 to check the next cue in the sequence. If the response to the cue in 65 is the incorrect response then 67 displays a box to the user to indicate that the user has an invalid entry and then returns to 63 to try another entry. If the response is correct in 66 and it is the last response in the sequence 68 then the user has completed the sequence correctly and the clock stops in 69 and the counters for invalid number of clicks and valid clicks are shown to the user in some type of window in the computer. The user then has the option in 70 to do another information set and sequence or repeat this learning sequence.

Should it be determined that the execution of the program should be re-initialized, the user can select with the mouse 20 the refresh button on the display 14 which will start the program from the beginning. Data will be stored for the user, to keep his data current and to show statistically how the users are performing on all information sets.

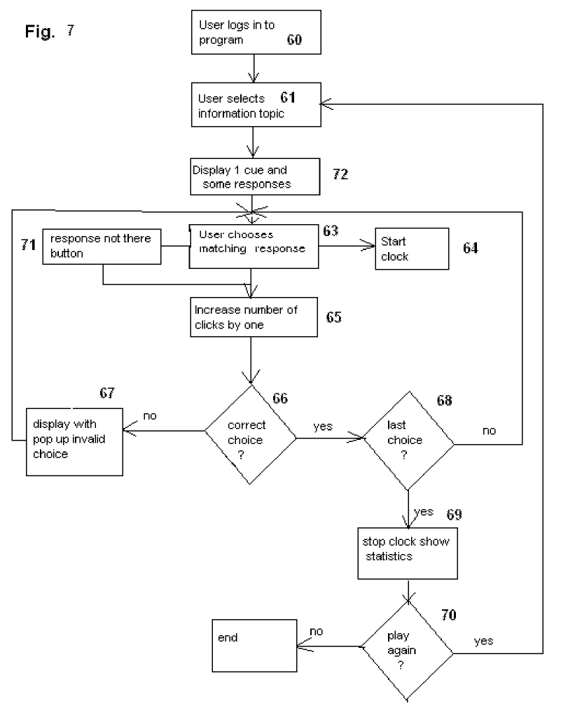

FIG. 7 discloses a difference from FIG. 6 flowchart by showing less than all the responses in 72, where the matching correct response may not be displayed. If the user selects 71 the response not displayed button, then the clicks are increased by one in 65 and the correct choice in 66 is determined as in FIG. 6. When the response not displayed button is selected in the correct case, the sequence continues as in FIG. 6.

It can be seen that the disclosed invention not only enhances the ability of the user to learn information through the sequential learning of multiple pieces of information learned by repetition. Thus, the disclosed invention permits the personal computer system PC to be used in a manner which enhances the learning capabilities of the user while minimizing possibilities of boredom.

While this invention has been described as having a preferred design, it is understood that it is capable of further modifications, uses and/or adaptations, following the general principle of the invention and including such departures from the present disclosure has come within known or customary practice in the art to which the invention pertains, and as may be applied to the central features hereinbefore set forth, and fall within the scope of the invention of the limits of the appended claims.

What is claimed is:

1. A method of displaying information for learning purposes in a computer, comprising the steps of:
(a) presenting information to be learned to a user so that the information to be learned becomes learned information;
(b) presenting information to the user for testing whether the learned information is known by the user;
(c) presenting a simulated set of flashcards; where a flashcard holds a first cue element and a non-related second response element;

2. The method according to claim 1, including the steps of:
(a) providing within a computer an information set of simulating a set of flashcards, including at least a first information group, the first information group including a plurality of discrete information element pairs each having a first cue element and a related second response element;
(b) presenting a plurality of simulated flashcards, where a first flashcard holds a first cue element and a second flashcard holds the related second response element;
(c) arranging within the computer the discrete information elements in a sequence;
(d) displaying each of the first and second elements of the discrete information elements based upon a user input;
(e) displaying all or some of the response cue elements randomly;

3. The method according to claim 2, including the steps of displaying with a display operably associated with the computer:
(a) one of the cue elements and all of the response cue elements in the information group;
(b) the first cue element of a flashcard in the sequence and all of the response cue elements in the information group, based upon a user input of one of the response cue elements, the display will provide feedback indicating either a correct or incorrect user input;
(c) a correct user input of the response cue element to the current displayed cue element in the sequence, results in the next cue element displayed in the sequence;
(d) an incorrect user input of the response cue element to the current displayed cue element in the sequence, results in notification to the user of an incorrect user input;

4. The method according to claim 2, including the step of displaying with a display operably associated with the computer:
(a) more than one of the cue elements and all of the response cue elements in the information group;
(b) more than one of the first cue elements in a sequence and all of the response cue elements in the information group, based upon a user input of one of the response cue elements, the display will provide feedback indicating either a correct or incorrect user input;
(c) a correct user input of the response cue element to the correct first cue element displayed in the sequence, results in the next cue element displayed in the sequence;
(d) an incorrect user input of the response cue element to the correct cue element displayed in the sequence, results in notification to the user of an incorrect response cue via user input;

5. The method according to claim 2, including the step of displaying with a display operably associated with the computer:
(a) one of the cue elements and some but not all of the response cue elements in the information group, where the correct response cue element is displayed;
(b) the first cue element in a sequence and some but not all of the response cue elements in the information group, based upon a user input of one of the response cue elements, the display will provide feedback indicating either a correct or incorrect user input;
(c) a correct user input of the response cue element to the cue element displayed in the sequence, results in the next cue element displayed in the sequence;
(d) an incorrect user input of the response cue element to the cue element displayed in the sequence, results in notification to the user of an incorrect response cue via user input;

6. The method according to claim 2, including the step of displaying with a display operably associated with the computer:
(a) more than one of the cue elements and some but not all of the response cue elements in the information group, where the correct response cue element is displayed;
(b) more than one of the cue elements in a sequence and some but not all of the response cue elements in the information group, based upon a user input of one of the response cue elements, the display will provide feedback indicating either a correct or incorrect user input;
(c) a correct user input of the response cue element to the correct cue element displayed in the sequence, results in the next cue element displayed in the sequence;
(d) an incorrect user input of the response cue element to the correct cue element displayed in the sequence, results in notification to the user of an incorrect response cue via user input;

7. The method according to claim 3, including the step of:
(a) arranging within the computer a sequence that is deliberate;

8. The method according to claim 3, including the step of:
(a) arranging within the computer a sequence that is random;

9. The method according to claim 3, including the steps of:
(a) monitoring the user's performance in each of steps 2 (a), (b), (c), (d), and steps 3 (a), (b), (c), (d);

10. The method according to claim 3, further comprising the steps of providing a difficulty factor, initialized by the computer, or input by the user to increase the number of cue elements;

11. The method according to claim 3, further comprising the steps of providing a difficulty factor, initialized by the computer, or input by the user to decrease the number of response elements;

12. The method according to claim 3, further comprising the steps of providing a difficulty factor, initialized by the computer, or chosen by the user to delay the notification to the user, that the incorrect response cue has been selected;

13. The method according to claim 3, wherein the information to be learned by the user is obtained from one of a text source, an image source, an audible sound source, a computer, the Internet, animation, video, and an electrical device.:

14. The method according to claim 3, wherein the information to be learned by the user is presented to the user at least one of visually, and auditorially.

15. The method according to claim 3, wherein the steps of the method are embodied as one of computer software, a signal carrier wave format to be used on an Internet-based system, machine-executable instructions, computer-executable instructions for operation on a processor-based system including at least one of a computer, a telephone, a personal digital assistant and an information transmission device.

16. The method according to claim 3, wherein the steps of the method are performed via one of a paper-based system, a computer-based system, a human-based system, and a system that presents information to a person or organism for learning and future retrieval of the information.

17. The method according to claim 3, wherein the steps of the method are performed via a processor-based system.

18. The method according to claim 3, wherein the steps of the method are performed via a non-processor-based system.

19. The method according to claim 3, wherein the steps of the method are performed via at least one of a processor, a central processing unit, a computer, a telephone, a cellular telephone, a personal digital assistant, a hand-held electronic device, an information transmission device and a digital data/information transmission device which performs the steps via processing of instructions embodied in machine readable code or computer executable code.

20. The method according to claim 3, further comprising the steps of presenting the information to be learned and the learned information via discrete information elements each including a cue and a response and arranging the information to be learned in a sequence where each cue and response is designed to fit in sequentially by utilizing parts of any audio source, such as Radio, TV, stereo, CD, tape, and the like.

21. The method according to claim 3, further comprising the steps of presenting the information to be learned and the learned information via discrete information elements each including a cue and a response and arranging the information to be learned in a sequence where each cue and response is designed to fit in sequentially by utilizing parts of any video source, such as TV, CATV, VCR, video disk players, closed circuit TV, and the like.

22. The method according to claim 3, further comprising the steps of presenting the information to be learned and the learned information via discrete information elements each including a cue and a response and arranging the information to be learned in a sequence where each cue and response is designed to fit in sequentially by utilizing parts of any text source, such as a book, paper, internet web page, newspaper, and the like.

23. The method according to claim 3, further comprising the steps of presenting the information to be learned and the learned information via discrete information elements each including a cue and a response and arranging the information to be learned in a sequence where each cue and response is designed to fit in sequentially by utilizing parts of any image source, such as a painting, comic strip, animation, photograph, digital image, graphic and the like.

24. The method according to claims 3, 4, 5, and 6, further comprising the steps of randomly scrambling the remaining displayed response cue elements after the user correctly responds to a cue element;

25. The method according to claims 5, or 6, further comprising the steps of not displaying the correct response cue element, where the user input is to respond that the correct response cue is not available;

26. The method according to claim 2, further comprising the steps of presenting the information to be learned and the learned information via discrete information elements each including more than two elements per discrete information element set, each including a cue, a response and a follow up response and arranging the information to be learned in a sequence where each of the element sets are designed to fit in sequentially by utilizing parts of a text source, as in a book, any textual source, or web page, video source, or audio source.

27. The method according to claim 2, further comprising the steps of presenting the information to be learned and the learned information via discrete information elements each including two elements per discrete information element set, each including a cue, a response and arranging the information to be learned in a sequence where each of the element sets are designed to fit in sequentially by utilizing a combination of input types of a text source, a video source, an audio source and an image source.

28. The method according to claim 2, further comprising the steps of presenting the information to be learned and the learned information via discrete information elements each including more than three elements per discrete information element set, and arranging the information to be learned in a sequence where each of the element sets are designed to fit in sequentially by utilizing parts of a text source, as in a book, any textual source, or web page, video source, or audio source.

29. The method according to claim 1, further comprising the steps of presenting the information to be learned and the learned information via discrete information elements each including two elements per discrete information element set, and arranging the information to be learned in a sequence where each of the element sets are sequentially placed; where the cue element of the element pair uses multiple parts of an image source where for example each individual image is of a coin, and multiple coins on one flashcard have a numerical value which is the sum of the coins and is represented by the response cue.

30. The method according to claim 1, further comprising the steps of presenting the information to be learned and the learned information via discrete information elements each including two elements per discrete information element set, and arranging the information to be learned in a sequence where each of the element sets are sequentially placed; where the complete sequence is executed and treated as a quiz, where the amount of time to complete the sequence is counted and invalid selections are counted towards a grading system.
